(19) United States
(12) Patent Application Publication
(10) Pub. No.: US 2012/0259682 A1
(43) Pub. Date: Oct. 11, 2012

(54) Methods and Systems for Incentivizing an Acquisition of a Good or Service

(76) Inventor: Adam Coldwell, South Easton, MA (US)

(21) Appl. No.: 13/359,511

(22) Filed: Jan. 27, 2012

Related U.S. Application Data
(60) Provisional application No. 61/473,301, filed on Apr. 8, 2011.

(51) Int. Cl. G06Q 30/02

(52) U.S. Cl. 705/14.1

(57) ABSTRACT

A method for incentivizing an acquisition of a good or service includes identifying a plurality of prices for a plurality of items, the plurality of prices including a first price that is higher than a second price in the plurality of prices. The method includes associating a first reward with the first price. The method includes associating a second reward with the second price. The method includes determining to provide a refund to a first acquirer of at least one of the plurality of items at the first price when a threshold is reached. The method includes selling one of the plurality of items for the first price by offering the first reward and the refund.

### CROSS-REFERENCE TO RELATED APPLICATIONS

This application claims priority from U.S. Provisional Patent Application Ser. No. 61/473,301 filed on Apr. 8, 2011 entitled “A method of incentivizing networked transactions including one or more acquirers of an item,” which is hereby incorporated by reference.

### BACKGROUND

The disclosure relates to incentivizing acquisitions. More particularly, the methods and systems described herein relate to incentivizing acquisitions of a good or service.

It is common practice for sellers of versioned goods (e.g., goods that are periodically replaced with newer models, as with consumer electronics or automobiles) and time-sensitive services to raise and lower prices without warning in an effort to maximize profits when demand is high and to induce sales when sales are low. As a result of these unannounced pricing changes, purchasers often pay significantly different amounts for identical or nearly identical goods and services even within very narrow time periods.

Value-conscious consumers who pay more than others may regret their purchase decisions, feel dissatisfied with the seller, and/or return their purchases. Those who purchase at the lowest prices may be satisfied with their purchase, but approach future purchasing decisions with unrealistic pricing expectations. Beyond the potentially damaging effects of regrets, dissatisfaction, and unrealistic pricing expectations, collective purchase delays, lost sales, and foregone sales exacerbate the need for sellers to offer significant pricing discounts to spur sales before the introduction of new versions and approaching deadlines necessitate the broad price depreciation of excess inventory.

### SUMMARY

In one aspect, a method for incentivizing an acquisition of a good or service includes identifying a plurality of prices for a plurality of items, the plurality of prices including a first price that is higher than a second price in the plurality of prices. The method includes associating a first reward with the first price. The method includes associating a second reward with the second price. The method includes determining to provide a refund to a first acquirer of at least one of the plurality of items at the first price when a threshold is reached. The method includes selling one of the plurality of items for the first price by offering the first reward and the refund.

In another aspect, a method for identifying a price differential between two acquisitions of goods or services and rewarding one of a plurality of acquirers includes providing, by an acquisition incentive system, to a first acquirer using a first client device, an identification of an acquisition opportunity. The method includes receiving, by the acquisition incentive system, from the first client device, a request to acquire the item described by the identification of the acquisition opportunity at a first price described by the identification of the acquisition opportunity. The method includes providing, by the acquisition incentive system, to the first acquirer, a first reward associated with the first price and described by the identification of the acquisition opportunity. The method includes providing, by the acquisition incentive system, to a second acquirer using a second client device, the identification of an acquisition opportunity. The method includes receiving, by the acquisition incentive system, from the second client device, a request to acquire a second item described by the identification of the acquisition opportunity at a second price described by the identification of the acquisition opportunity, the second price lower than the first price. The method includes providing, by the acquisition incentive system, to the second acquirer, a second reward having a value lower than the first reward. The method includes identifying, by the acquisition incentive system, a difference between the first price and the second price. The method includes refunding, by the acquisition incentive system, to the first acquirer, the identified difference between the first price and the second price.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A-1C are block diagrams depicting embodiments of computers useful in connection with the methods and systems described herein;

FIG. 2A is a block diagram depicting an embodiment of a system for incentivizing an acquisition of a good or service;

FIG. 2B is a block diagram depicting an embodiment of a system for incentivizing an acquisition of a good or service;

FIG. 2C is a block diagram depicting one embodiment of a system 200 including an acquisition opportunity specification interface 204 and an application opportunity display interface 206;

FIG. 2D is a screen shot depicting one embodiment of an acquisition opportunity specification interface 204;

FIG. 2E is a screen shot depicting one embodiment of an acquisition opportunity display interface 206;

FIG. 3 is a flow diagram depicting an embodiment of a method for incentivizing an acquisition of a good or service;

FIG. 4 is a flow diagram depicting an embodiment of a method for incentivizing an acquisition of a good or service;

FIG. 5 is a flow diagram depicting an embodiment of a method for identifying a price differential between two acquisitions of goods or services and incentivizing one of a plurality of acquirers; and

FIG. 6 is a flow diagram depicting another embodiment of a method for identifying a price differential between two acquisitions of goods or services and incentivizing one of a plurality of acquirers.

### DETAILED DESCRIPTION

In some embodiments, the methods and systems described herein provide functionality for incentivizing an acquisition of a good or service. Before describing these methods and systems in detail, however, a description is provided of a network in which such methods and systems may be implemented.

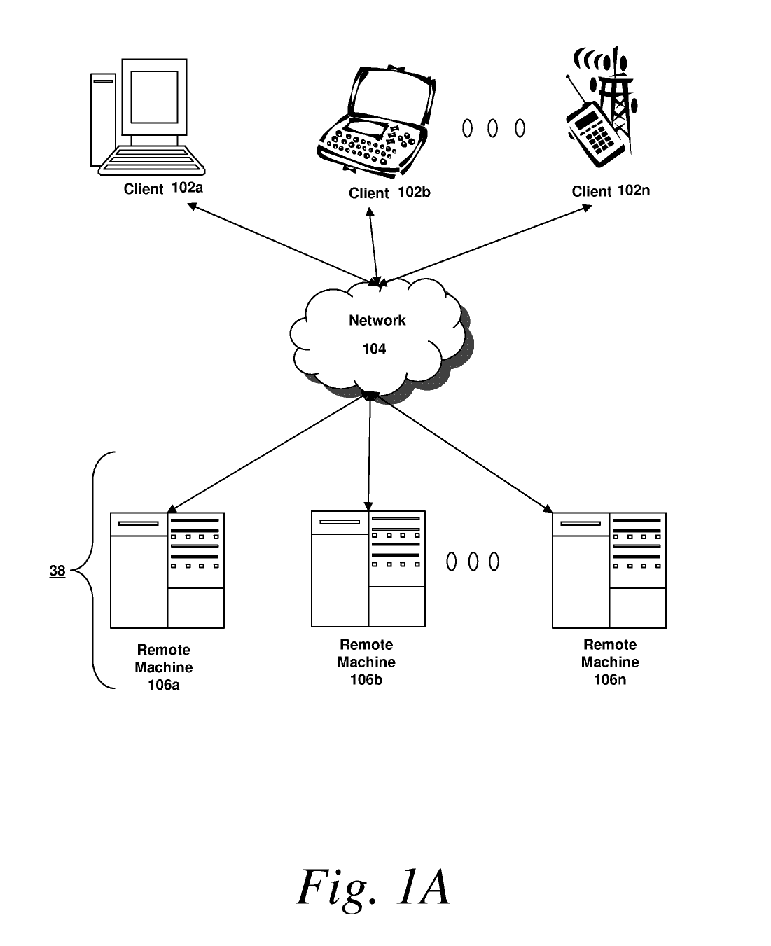

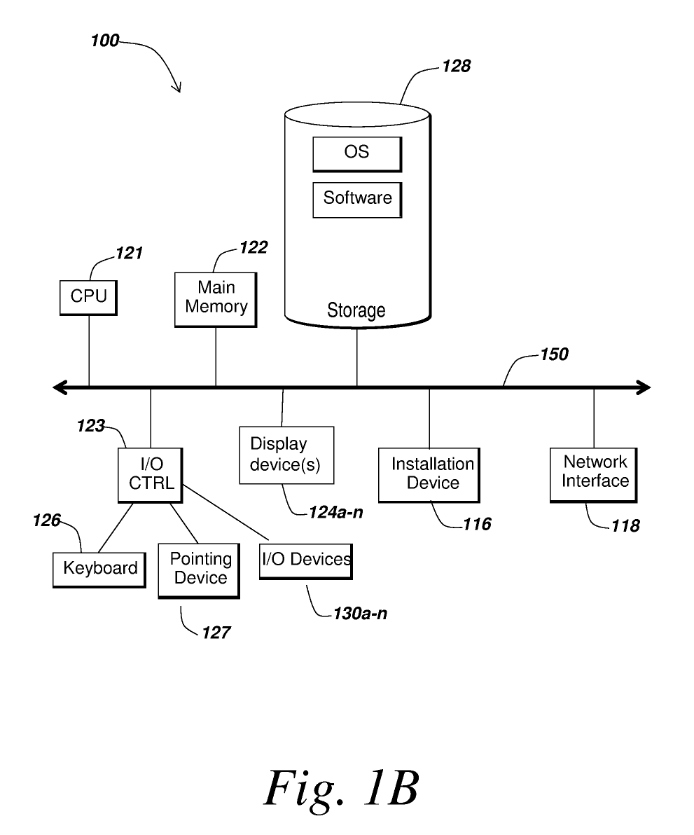

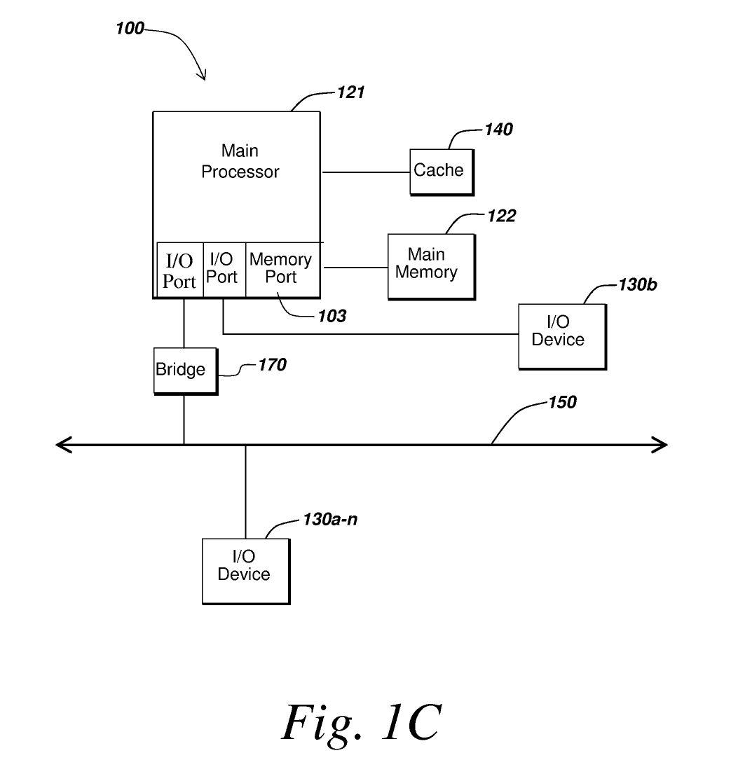

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS, manufactured by Apple Inc. of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc., of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc. of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices, manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices, manufactured by Apple Inc.; the PlayBook, manufactured by Research in Motion; the Cruz line of devices, manufactured by Velocity Micro, Inc. of Richmond, Va.; the Folio and Thrive line of devices, manufactured by Toshiba America Information Systems, Inc. of Irvine, Calif.: the Galaxy line of devices, manufactured by Samsung; the HP Slate line of devices, manufactured by Hewlett-Packard; and the Streak line of devices, manufactured by Dell, Inc. of Round Rock, Tex.

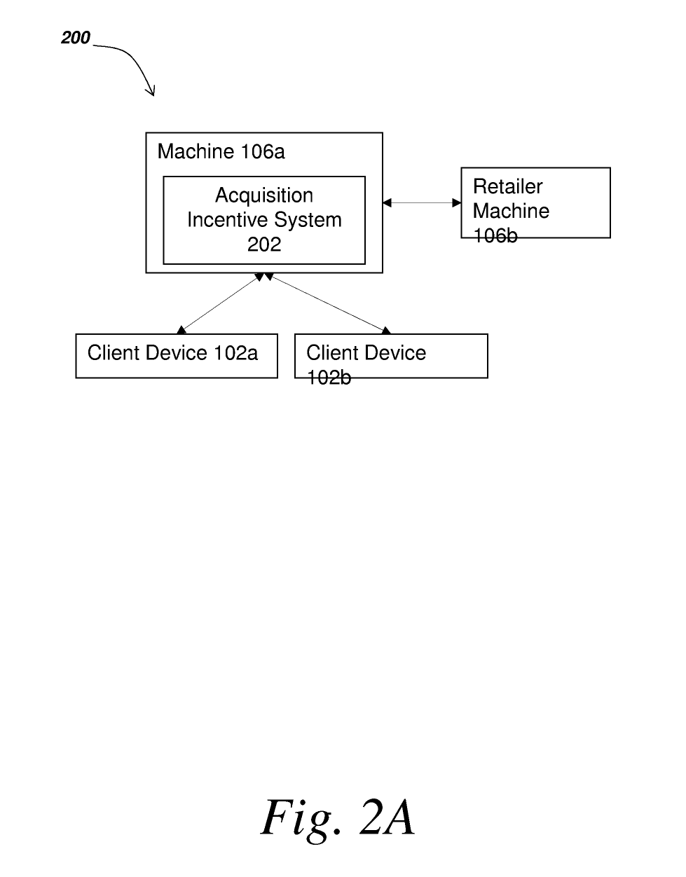

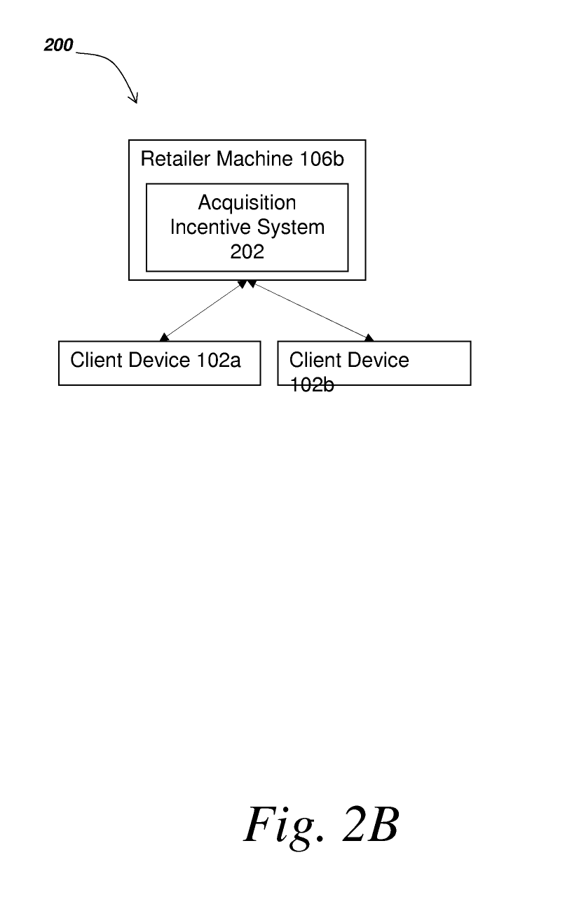

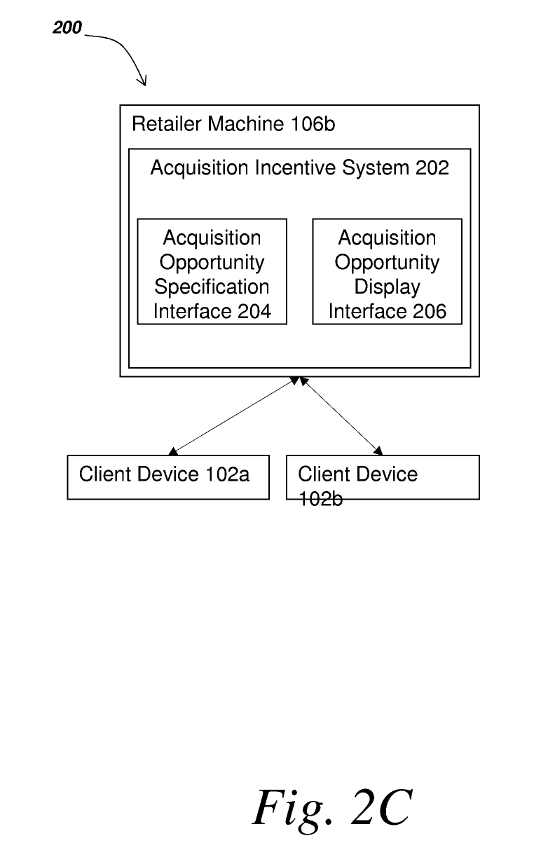

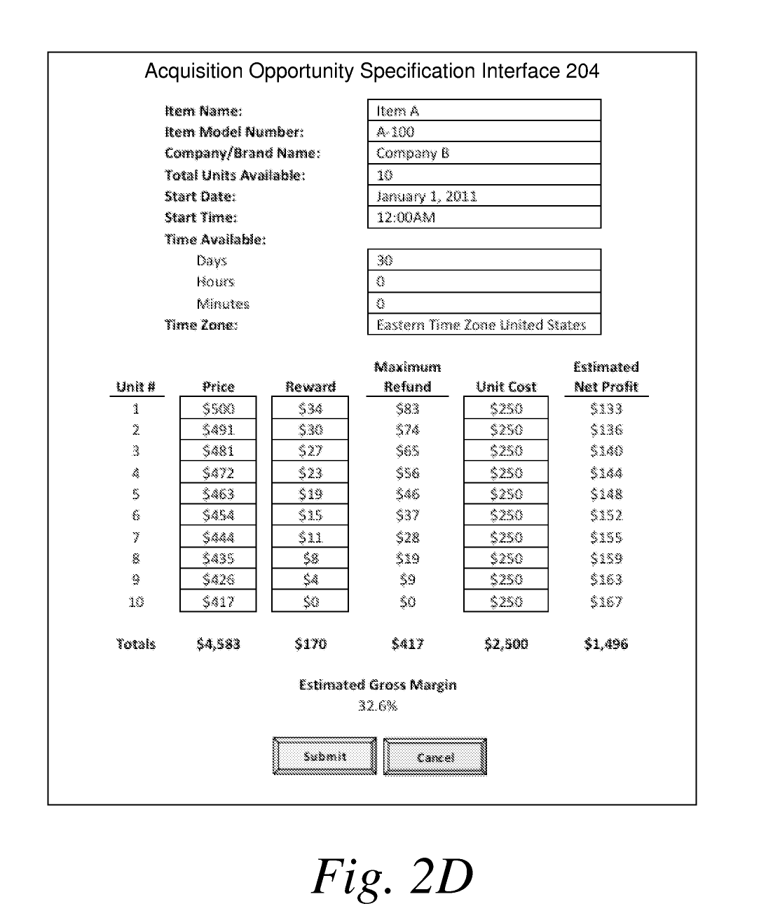

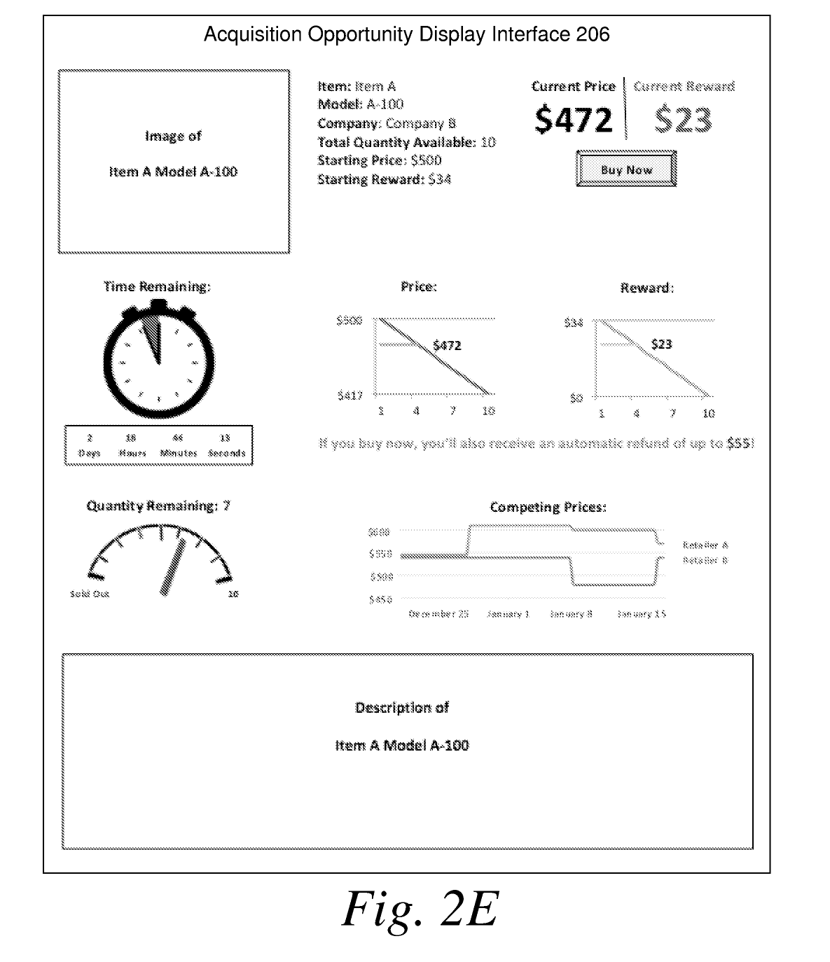

Referring now to FIG. 2A, a block diagram depicts one embodiment of a system for incentivizing an acquisition of a good or service. In brief overview, the system includes an acquisition incentive system 202, a machine 106a, a retailer machine 106b, a client device 102a and a client device 102b. In some embodiments, the machine 106a, the retailer machine 106b, the client device 102a, and the client device 102b are machines as described above in connection with FIGS. 1A-1C. Although referred to herein as a retailer machine 106b, it should be understood that the machine 106b may be associated with any entity making goods or services available for acquisitions and need not be a commercial retail entity.

Although depicted in FIG. 2A as separate entities for clarity, the acquisition incentive system 202 and the retailer machine 106b may be provided by a single entity. Referring now to FIG. 2B, a block diagram depicts an embodiment of the system in which the retailer machine 106b executes the acquisition incentive system 202. In some embodiments, a single corporate entity operates both the acquisition incentive system 202 and the retailer machine 106b; for example, a company may execute the acquisition incentive system 202 on the retailer machine 106b, the company may own both the machine 106a and the retailer machine 106b, or the company may license the right to execute the acquisition incentive system 202 on the retailer machine 106b from a second company.

Referring again to FIG. 2A, and in one embodiment, a first acquirer of a good or service uses the client device 102a. In another embodiment, a second acquirer of a good or service uses the client device 102b. In some embodiments, the first acquirer and the second acquirer are the same person who uses different machines; for example, a single person may use a personal computer (client device 102a) for a first acquisition and may use a smartphone (client device 102b) for a second acquisition. In other embodiments, the first acquirer and the second acquirer are the same person using a single computing device at different times; for example, client device 102a may refer to the computing device used to acquire an item at a first time and client device 102b refers to a second use of the computing device to acquire a second item at a second time. In some embodiments, the first acquirer and the second acquirer are the same person using a single computing device to make multiple acquisitions at substantially the same time (e.g., a user may place an order for two items at the same time and apply a reward received for purchasing a first of the two items to paying for a second of the two items). In further embodiments, the first acquirer and the second acquirer may be different people using a single computing device (such as a machine shared by roommates, family members, or the general public); for example, client device 102a may refer to a computing device used by the first acquirer and client device 102a may refer to the same computing device when used by the second acquirer.

In one embodiment, the acquisition incentive system 202 executes on the machine 106a. In another embodiment, the acquisition incentive system 202 is provided as a software application including functionality for implementing the methods described herein. In still another embodiment, the functionality for implementing the methods described herein is distributed across a plurality of machines 106a and the acquisition incentive system 202 includes the plurality of machines 106a.

In one embodiment, the acquisition incentive system 202 includes a user interface with which a user of the retailer machine 106b identifies a plurality of items for which the acquisition incentive system 202 should identify incentivizing prices and rewards; for example, the acquisition incentive system 202 may provide a web page(s) displaying the user interface. In another embodiment, the acquisition incentive system 202 includes a user interface with which the user of the retailer machine 106b identifies prices and rewards and receives feedback from the acquisition incentive system 202 regarding a level of incentive provided by the identified prices and rewards.

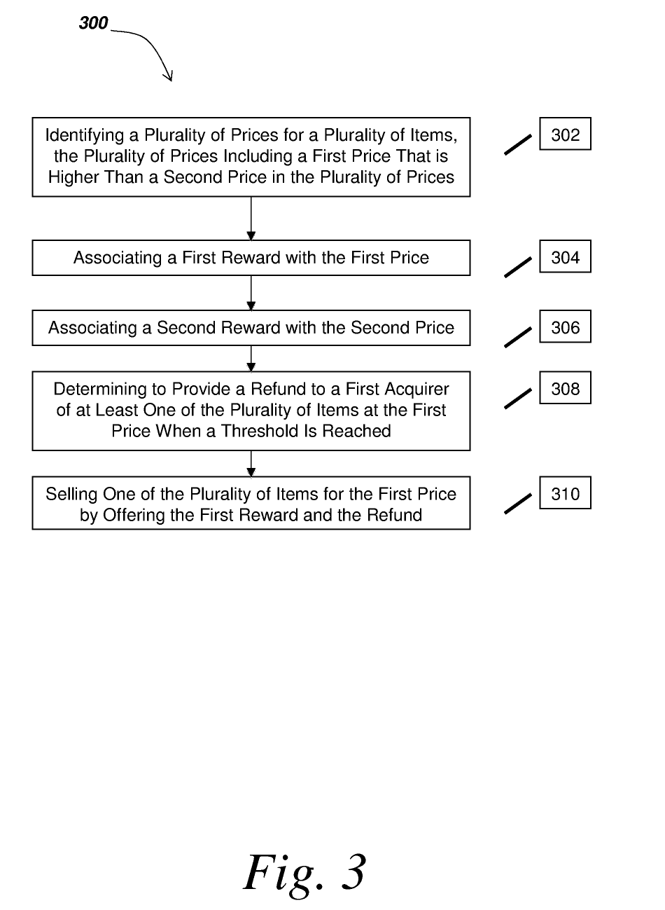

Referring now to FIG. 2C, a block diagram depicts one embodiment of a system 200 including an acquisition opportunity specification interface 204 and an application opportunity display interface 206. In one embodiment, the acquisition incentive system 202 includes functionality for specifying acquisition opportunities. For example, and as will be described in greater detail below in connection with FIG. 3, the acquisition incentive system 202 may receive an identification of a plurality of items available for acquisition and may generate a specification describing a variety of prices and rewards associated with the items during time intervals in which the items are available for acquisition; a user of the system 200 may provide the acquisition incentive system 202 with the identifications through the acquisition opportunity specification interface 204. In another embodiment, the acquisition incentive system 202 includes an acquisition opportunity display interface 206 providing functionality for displaying an acquisition opportunity.

Referring now to FIG. 2D, a screen shot depicts one embodiment of the acquisition opportunity specification interface 204. As shown in FIG. 2D, the acquisition opportunity specification interface 204 includes user interface elements with which users may describe an acquisition opportunity including, without limitation, information such as an item name, an item model number, an item brand name, a number of items available, a time period within which the acquisition opportunity is available, and a specification of prices and associated rewards.

Referring now to FIG. 2E, a block diagram depicts one embodiment of an acquisition opportunity display interface 206. In one embodiment, the acquisition incentive system 202 includes a user interface (e.g., the acquisition opportunity display interface 206) with which potential acquirers may view items available for acquisition, place orders to acquire items, and view and redeem rewards received in connection with acquiring particular items.

Referring now to FIG. 3, a flow diagram depicts one embodiment of a method 300 for incentivizing an acquisition of a good or service. In brief overview, the method 300 includes identifying a plurality of prices for a plurality of items, the plurality of prices including a first price that is higher than a second price in the plurality of prices (302). The method 300 includes associating a first reward with the first price (304). The method 300 includes associating a second reward with the second price (306). The method 300 includes 300 determining to provide a refund to a first acquirer of at least one of the plurality of items at the first price when a threshold is reached (308). The method 300 includes 300 selling one of the plurality of items for the first price by offering the first reward and the refund (310).

Referring now to FIG. 3 in greater detail, and in connection with FIGS. 2A-2B, the method 300 includes identifying a plurality of prices for a plurality of items, the plurality of prices including a first price that is higher than a second price in the plurality of prices (302). In one embodiment, a user of the retailer machine 106b identifies the plurality of prices for the plurality of items. In another embodiment, the retailer machine 106b transmits the identification to the acquisition incentive system 202. In still another embodiment, the user of the retailer machine 106b accesses a user interface provided by the acquisition incentive system 202 to identify the plurality of prices (e.g., by communicating with the acquisition incentive system 202 via a network 104 to access a web site provided by the acquisition incentive system 202).

In some embodiments, the user of the retailer machine 106b transmits to the acquisition incentive system 202 an identification of the plurality of items available for acquisition. In one of these embodiments, the acquisition incentive system 202 identifies the plurality of prices. For example, upon receiving the identification of the plurality of items available for acquisition, the acquisition incentive system 202 may make a recommendation as to the prices for each of the items. In another example, the user of the retailer machine 106b transmits, to the acquisition incentive system 202, an identification of an objective—for example, objectives may include, without limitation, a number of items to be acquired, a date by when the items should be acquired, and a profit to be made from the acquisition of the items—and the acquisition incentive system 202 may make a recommendation as to the prices that should be set in order to meet the objective.

The method 300 includes associating a first reward with the first price (304). In one embodiment, a user of the retailer machine 106b identifies the first reward. In another embodiment, the user of the retailer machine 106b identifies a value of the first reward based on the first price. In another embodiment, the user of the retailer machine 106b associates the first reward with the first price. In another embodiment, the retailer machine 106b transmits the association to the acquisition incentive system 202. In still another embodiment, the user of the retailer machine 106b accesses a user interface provided by the acquisition incentive system 202 to associate the first reward with the first price (e.g., by communicating with the acquisition incentive system 202 via a network 104 to access a web site provided by the acquisition incentive system 202).

In one embodiment, the acquisition incentive system 202 identifies the first reward. In another embodiment, the acquisition incentive system 202 identifies a value of the first reward based on the first price. In another embodiment, the acquisition incentive system 202 associates the first reward with the first price. In still another embodiment, the acquisition incentive system 202 associates the first reward with the first price based upon the identified plurality of prices. In yet another embodiment, the acquisition incentive system 202 associates the first reward with the first price based upon an objective specified by a retailer associated with the retailer machine 106b (e.g., via an instruction sent over the network 104 or by directly accessing the acquisition incentive system 202; for example, the retailer may specify an amount of profit to be made by selling the plurality of items, specify a minimum subset of the plurality of items to be sold and the acquisition incentive system 202 identifies a type or amount of reward to associate with the second price in order to satisfy the requirement.

The method 300 includes associating a second reward with the second price (306). In one embodiment, a user of the retailer machine 106b identifies the second reward. In another embodiment, a user of the retailer machine 106b identifies a value of the second reward based on the second price. In another embodiment, the user of the retailer machine 106b associates the second reward with the second price. In another embodiment, the retailer machine 106b transmits the association to the acquisition incentive system 202. In still another embodiment, the user of the retailer machine 106b accesses a user interface provided by the acquisition incentive system 202 to associate the second reward with the second price (e.g., by communicating with the acquisition incentive system 202 via a network 104 to access a web site provided by the acquisition incentive system 202).

In one embodiment, the acquisition incentive system 202 identifies the second reward. In another embodiment, the acquisition incentive system 202 identifies a value of the second reward based on the second price. In another embodiment, the acquisition incentive system 202 associates the second reward with the second price. In still another embodiment, the acquisition incentive system 202 associates the second reward with the second price based upon the identified plurality of prices. In yet another embodiment, the acquisition incentive system 202 associates the second reward with the second price based upon an objective specified by a retailer associated with the retailer machine 106b; for example, the retailer may specify an amount of profit to be made by selling the plurality of items, specify a minimum subset of the plurality of items to be sold and the acquisition incentive system 202 identifies a type or amount of reward to associate with the second price in order to satisfy the requirement.

In one embodiment, the method 300 includes associating a second reward with the second price, the second reward having a lower value than a value of the first reward. For example, the acquisition incentive system 202 may recommend that the user of the retailer machine 106b make an item available for acquisition at a first price with a first reward; in order to incentivize the acquirer of the item at the first price to make a decision to acquire the item sooner rather than later, the first price may be accompanied by a first reward that is higher than the second reward that accompanies a lower second price. An acquirer of the item at the first price may know that she is paying a higher price than she will pay if she waits to make the acquisition later when a second item of the same type is available at a lower price—but she also knows that the reward received for making the acquisition at the first, higher price is higher than the reward accompanying the second, lower price. Such an embodiment may be useful in a scenario where the items available for acquisition are not yet popular or in high demand; for example, where the person making the acquisition is an early adopter of new technology or of other versioned goods or time-sensitive services.

In another embodiment, the method 300 includes associating a second reward with the second price, the second reward having a higher value than a value of the first reward. For example, in such an embodiment, the user of the retailer machine 106b may make a plurality of items available at a certain price and, as time passes, wish to lower the price to incentivize others to acquire the items; in order to further incentivize others to acquire the items, the user may offer higher rewards as time passes. Such an embodiment may be useful in a scenario where the user of the retailer machine 106b has the objective of getting as many items acquired as possible. In some embodiments, instead of targeting early adopters or late adopters (which typically implies that the adopters are assessing a new technology), the rewards are identified so as to incentivize early or late decision makers for whom the state of technology is irrelevant to the process of making a decision.

In still another embodiment, the method 300 includes associating a second reward with the second price, the second reward having a substantially similar value as the first reward. For example, the user of the retailer machine 106b may determine that offering a particular reward with the items available for acquisition makes it more likely that others will acquire the item; for instance, in some markets, a consumer good or service may be more likely to be sold if it is accompanied by a warranty or accessory, or instantly available credit (e.g., a credit applicable to another item available for acquisition), regardless of the price of the consumer good or service.

The method 300 includes determining to provide a refund to a first acquirer of at least one of the plurality of items at the first price when a threshold is reached (308). In some embodiments, the acquisition incentive system 202 analyzes the identified plurality of prices and the associations between the rewards and the prices and determines, based upon the analyses when to provide the refund to the first acquirer. The rewards and refunds may be provided at different times depending upon the objectives of the party making the items available for acquisition. In one embodiment, the method 300 includes determining to provide the refund to the first acquirer when a threshold number of items is acquired. In another embodiment, the method 300 includes determining to provide a refund to the first acquirer when a second acquirer acquires at least one of the plurality of items at the second price. In still another embodiment, the method 300 includes determining to provide a refund to the first acquirer when a period of time elapses. In yet another embodiment, the method 300 includes determining to provide a refund to the first acquirer when the first acquirer requests the refund.

In some embodiments, in addition to providing the refund at different times, the value of the refunds is identified at different times. In one of these embodiments, the value of the refund to provide to the first acquirer is identified when the price is set. In another of these embodiments, the value of the refund to provide to the first acquirer is identified after the price for the items available for acquisition is set; for example, when a second acquirer completes an acquisition or when a threshold number of items is acquired. In some embodiments, the method 300 includes identifying, when the second acquirer acquires at least one of the plurality of items at the second price, the value of the refund to provide to the first acquirer. In other embodiments, the method 300 includes identifying, when a threshold number of items is acquired, the value of the refund to provide to the first acquirer. In further embodiments, the method 300 includes identifying, when a period of time elapses, the value of the refund to provide to the first acquirer.

The method 300 includes selling one of the plurality of items for the first price by offering the first reward and the refund (310). In one embodiment, a specific value of the refund is specified. In another embodiment, a potential refund is specified; for example, if the refund is not calculated until after the second acquirer makes an acquisition at a second price, a specific value of the refund may not be specified and the potential refund may be used. In one embodiment, offering a reward and a refund provides an incentive to potential acquirers of the items, encouraging the acquirers to make an acquisition decision they might otherwise have deferred.

In some embodiments, the acquisition incentive system 202 receives information about the plurality of items and generates an acquisition opportunity describing the plurality of items available for acquisition. In one of these embodiments, the acquisition opportunity specifies, by way of example and without limitation, the item or items available for acquisition, any time interval during which the item or items are available for acquisition, and any minimum or maximum quantities of the item available for acquisition. In another of these embodiments, the acquisition opportunity includes a pricing reference identifying how a price per item decreases, increases, or remains unchanged after another item is acquired. In still another of these embodiments, the pricing reference identifies how a price per item decreases, increases, or remains constant as time lapses during a time interval in which the plurality of items is available for acquisition. In another of these embodiments, the acquisition opportunity specifies whether rewards are associated with the plurality of items; for example, the acquisition opportunity may identify the first reward and the first price. In still another of these embodiments, the acquisition opportunity includes a reward reference identifying the reward associated with each item and identifying how the reward decreases, increases or remains unchanged after other items are acquired, as prices vary, or as time lapses. In yet another of these embodiments, the acquisition incentive system 202 makes the acquisition opportunity available to potential acquirers (e.g., by including the acquisition opportunity in an enumeration of items available for acquisition, the enumeration provided to potential acquirers, for example and without limitation, via email, text message, voice mail message, web page, or other form of communication over the network 104).

In some embodiments, the identifications and associations described herein are made manually (e.g., by a user of the retailer machine 106b or of the acquisition incentive system 202). In other embodiments, the identifications and associations described herein are automatically generated (e.g., by the acquisition incentive system 202). In further embodiments, some identifications and associations are made manually while others are made automatically.

In the embodiments described in connection with FIG. 3, the plurality of prices included a first price that is higher than a second price. However, in some embodiments, the prices remain the same while the rewards associated with the prices vary.

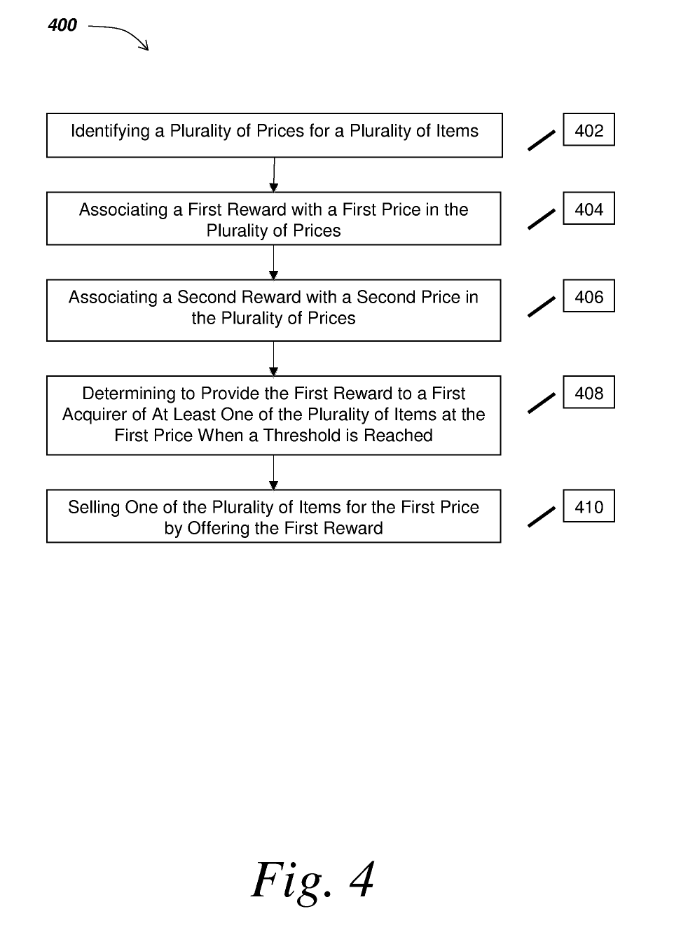

Referring now to FIG. 4, a flow diagram depicts one embodiment of a method 400 for incentivizing an acquisition of a good or service. In brief overview, the method 400 includes identifying a plurality of prices for a plurality of items (402). The method 400 includes associating a first reward with a first price in the plurality of prices (404). The method 400 includes associating a second reward with a second price in the plurality of prices (406). The method 400 includes determining to provide the first reward to a first acquirer of at least one of the plurality of items at the first price when a threshold is reached (408). The method 400 includes selling one of the plurality of items for the first price by offering the first reward (410).

Referring now to FIG. 4 in greater detail, and in connection with FIGS. 2A-2B and 3, the method 400 includes identifying a plurality of prices for a plurality of items (402). In one embodiment, the prices in the plurality of prices (and thus each price identified for each of the plurality of items) are substantially similar.

The method 400 includes associating a first reward with a first price in the plurality of prices (404). In one embodiment, the method 400 includes identifying a value of the first reward based on the first price. In some embodiments, the first reward is associated with the first price as described above in connection with FIG. 3.

The method 400 includes associating a second reward with a second price in the plurality of prices (406). In one embodiment, the method 400 includes identifying a value of the second reward based on the second price. In some embodiments, the second reward is associated with the second price as described above in connection with FIG. 3.

The method 400 includes determining to provide the first reward to a first acquirer of at least one of the plurality of items at the first price when a threshold is reached (408). In one embodiment, the method 400 includes determining to provide the first reward to the first acquirer when a period of time elapses. In another embodiment, the method 400 includes determining to provide the first reward to the first acquirer when a quantity threshold is reached. In still another embodiment, the method 400 includes determining to provide the first reward to the first acquirer when a second acquirer acquires at least one of the plurality of items at the second price. In some embodiments, the determination as to when to provide the reward is made as described above in connection with FIG. 3.

The method 400 includes selling one of the plurality of items for the first price by offering the first reward (410). In one embodiment, the method 400 includes selling a second of the plurality of items for the second price by offering the second reward. In some embodiments, selling one of the plurality of items occurs as described above in connection with FIG. 3.

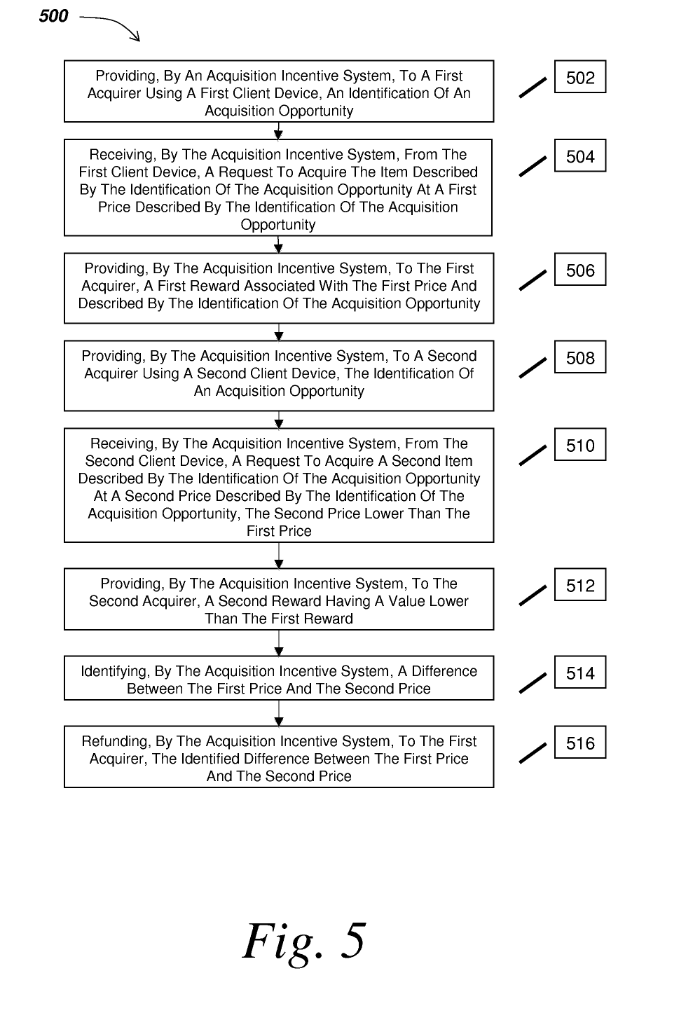

Referring now to FIG. 5, a flow diagram depicts one embodiment of a method 500 for identifying a price differential between two acquisitions of goods or services and incentivizing one of a plurality of acquirers. The method 500 includes providing, by an acquisition incentive system, to a first acquirer using a first client device, an identification of an acquisition opportunity (502). The method 500 includes receiving, by the acquisition incentive system, from the first client device, a request to acquire the item described by the identification of the acquisition opportunity at a first price described by the identification of the acquisition opportunity (504). The method 500 includes providing, by the acquisition incentive system, to the first acquirer, a first reward associated with the first price and described by the identification of the acquisition opportunity (506). The method 500 includes providing, by the acquisition incentive system, to a second acquirer using a second client device, the identification of an acquisition opportunity (508). The method 500 includes receiving, by the acquisition incentive system, from the second client device, a request to acquire a second item described by the identification of the acquisition opportunity at a second price described by the identification of the acquisition opportunity, the second price lower than the first price (510). The method 500 includes providing, by the acquisition incentive system, to the second acquirer, a second reward having a value lower than the first reward (512). The method 500 includes identifying, by the acquisition incentive system, a difference between the first price and the second price (514). The method 500 includes refunding, by the acquisition incentive system, to the first acquirer, the identified difference between the first price and the second price (516).

Referring now to FIG. 5 in greater detail, and in connection with FIGS. 2A, 2B, 3 and 4, the acquisition incentive system provides, to a first acquirer using a first client device, an identification of an acquisition opportunity (502). In one embodiment, a potential acquirer views an enumeration of items available for acquisition; for example, the acquisition incentive system 202 may provide a user interface enumerating items available for acquisition (e.g., via a network 104). In another embodiment, the potential acquirer selects one of the enumerated items and requests additional detail associated with the selected item. In still another embodiment, the acquisition incentive system 202 provides the potential acquirer with an acquisition opportunity that may include, by way of example, and without limitation, current price of the item, current reward for acquiring the item at the current price, an identification of a quantity of the item available, and any closing time when the acquisition opportunity will cease. In some embodiments, the acquisition incentive system 202 displays the identification of the acquisition opportunity via the acquisition opportunity display interface 206 described above in connection with FIG. 2E.

The acquisition incentive system receives, from the first client device, a request to acquire the item described by the identification of the acquisition opportunity at a first price described by the identification of the acquisition opportunity (504). In one embodiment, the first acquirer makes the request by interacting with an interface provided by the acquisition incentive system 202. In another embodiment, the acquisition incentive system 202 directs the first acquirer to a third party system for placing acquisition orders.

The acquisition incentive system provides, to the first acquirer, a first reward associated with the first price and described by the identification of the acquisition opportunity (506). In one embodiment, the acquisition incentive system 202 provides the first reward to the first acquirer. In another embodiment, the acquisition incentive system 202 directs the retailer machine 106b to provide the first reward to the first acquirer. In still another embodiment, the acquisition incentive system 202 directs a third party system to provide the first reward to the first acquirer. In some embodiments, implementation of the methods and systems described herein provide potential acquirers with the first reward at the time of the acquisition, which provides an incentive to complete an acquisition rather than to delay the acquisition.

The acquisition incentive system provides, to a second acquirer using a second client device, the identification of an acquisition opportunity (508). In one embodiment, the second acquirer views an enumeration of items available for acquisition; for example, the acquisition incentive system 202 may provide a user interface enumerating items available for acquisition (e.g., via a network 104). In another embodiment, the second acquirer selects one of the enumerated items and requests additional detail associated with the selected item. In still another embodiment, the acquisition incentive system 202 provides the second acquirer with an acquisition opportunity that may include, by way of example, and without limitation, current price of the item, current reward for acquiring the item at the current price, an identification of a quantity of the item available, and any closing time when the acquisition opportunity will cease.

The acquisition incentive system receives, from the second client device, a request to acquire a second item described by the identification of the acquisition opportunity at a second price described by the identification of the acquisition opportunity, the second price lower than the first price (510). In one embodiment, the second acquirer requests the acquisition by interacting with an interface provided by the acquisition incentive system 202. In another embodiment, the acquisition incentive system 202 directs the second acquirer to a third party system for placing acquisition orders.

The acquisition incentive system provides, to the second acquirer, a second reward having a value lower than the first reward (512). In one embodiment, the acquisition incentive system 202 provides the second reward to the second acquirer. In another embodiment, the acquisition incentive system 202 directs the retailer machine 106b to provide the second reward to the second acquirer. In still another embodiment, the acquisition incentive system 202 directs a third party system to provide the second reward to the second acquirer. In some embodiments, implementation of the methods and systems described herein provide acquirers with the second reward at the time of the acquisition, which provides an incentive to complete an acquisition rather than to delay the acquisition; for example, although the second reward has a lower value than the first reward, the second reward may also have a higher value than a third reward associated with a third price charged for acquiring the item still later in time.

The acquisition incentive system identifies a difference between the first price and the second price (514). In one embodiment, the second price is referred to as a final reference price. In another embodiment, the acquisition incentive system 202 calculates the final reference price by comparing all of the applicable reference prices charged to acquirers during the acquisition time interval and identifying the lowest reference price charged. In still another embodiment, the acquisition incentive system 202 calculates an item rebate for each item acquired during the acquisition time interval and credits each acquirer the applicable item rebate. In yet another embodiment, the acquisition incentive system 202 calculates the item rebate by subtracting the final reference price from the price charged for each item acquired during the acquisition time interval.

The acquisition incentive system refunds, to the first acquirer, the identified difference between the first price and the second price (516). In one embodiment, the method 500 includes refunding the identified difference when a threshold number of items is sold. In another embodiment, the method 500 includes refunding the identified difference when the second acquirer acquires the second item at the second price. In still another embodiment, the method 500 includes refunding the identified difference when a period of time elapses. In yet another embodiment, the method 500 includes refunding the identified difference when the first acquirer requests the refund.

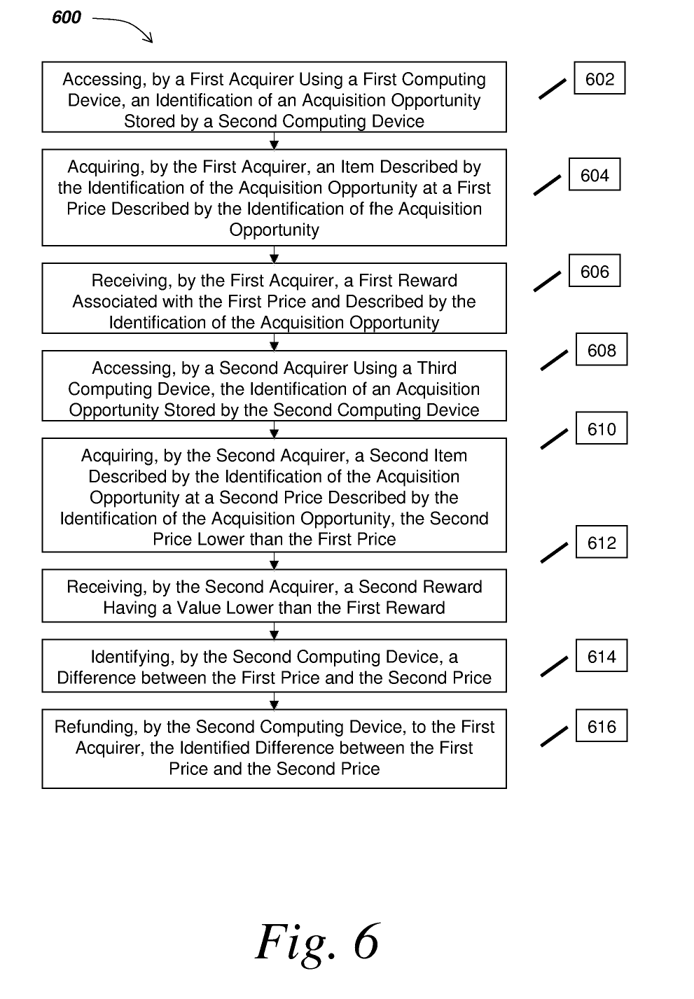

Referring now to FIG. 6, a flow diagram depicts one embodiment of a method 600 for identifying a price differential between two acquisitions of goods or services and incentivizing one of a plurality of acquirers. In brief overview, the method 600 includes accessing, by a first acquirer using a first computing device, an identification of an acquisition opportunity stored by a second computing device (602). The method 600 includes acquiring, by the first acquirer, an item described by the identification of the acquisition opportunity at a first price described by the identification of the acquisition opportunity (604). The method 600 includes receiving, by the first acquirer, a first reward associated with the first price and described by the identification of the acquisition opportunity (606). The method 600 includes accessing, by a second acquirer using a third computing device, the identification of an acquisition opportunity stored by the second computing device (608). The method 600 includes acquiring, by the second acquirer, a second item described by the identification of the acquisition opportunity at a second price described by the identification of the acquisition opportunity, the second price lower than the first price (610). The method 600 includes receiving, by the second acquirer, a second reward having a value lower than the first reward (612). The method 600 includes identifying, by the second computing device, a difference between the first price and the second price (614). The method 600 includes refunding, by the second computing device, to the first acquirer, the identified difference between the first price and the second price (616).

Referring now to FIG. 6 in greater detail, and in connection with FIGS. 2A-2B and 3-5, the method 600 includes accessing, by a first acquirer using a first computing device, an identification of an acquisition opportunity stored by a second computing device (602). In one embodiment, the first acquirer accesses the identification as described above in connection with FIG. 5.

The method 600 includes acquiring, by the first acquirer, an item described by the identification of the acquisition opportunity at a first price described by the identification of the acquisition opportunity (604). In one embodiment, the first acquirer acquires the item as described above in connection with FIG. 5.

The method 600 includes receiving, by the first acquirer, a first reward associated with the first price and described by the identification of the acquisition opportunity (606). In one embodiment, the first acquirer receives the first reward as described above in connection with FIG. 5.

The method 600 includes accessing, by a second acquirer using a third computing device, the identification of an acquisition opportunity stored by the second computing device (608). In one embodiment, the second acquirer accesses the identification as described above in connection with FIG. 5.

The method 600 includes acquiring, by the second acquirer, a second item described by the identification of the acquisition opportunity at a second price described by the identification of the acquisition opportunity, the second price lower than the first price (610). In one embodiment, the second acquirer acquires the second item as described above in connection with FIG. 5.

The method 600 includes receiving, by the second acquirer, a second reward having a value lower than the first reward (612). In one embodiment, the second acquirer receives the second reward as described above in connection with FIG. 5.

The method 600 includes identifying, by the second computing device, a difference between the first price and the second price (614). In one embodiment, the difference is identified as described above in connection with FIG. 5.

The method 600 includes refunding, by the second computing device, to the first acquirer, the identified difference between the first price and the second price (616). In one embodiment, the refund is provided as described above in connection with FIG. 5.

In one embodiment, when the potential acquirer decides to acquire an item, she places an acquisition order; at the time the acquisition order is placed, the acquirer is charged the applicable current price and is credited the applicable current reward. In another embodiment, when the accompanying threshold is reached (e.g., the maximum number of items available or the closing time is reached), a final reference price for the acquired item is determined by identifying the lowest current price charged to any acquirer of the item. In still another embodiment, each acquirer is then credited an item rebate that equals the amount they were charged for their item minus the final reference price; if the item rebate for an acquirer is less than or equal to zero, then no rebate credit is issued.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for incentivizing an acquisition of a good or service, it will now become apparent to one of skill in the art that other embodiments incorporating the concepts of the disclosure may be used. Therefore, the disclosure should not be limited to certain embodiments, but rather should be limited only by the spirit and scope of the following claims.

1. A method for incentivizing an acquisition of a good or service, the method comprising:
identifying a plurality of prices for a plurality of items, the plurality of prices including a first price that is higher than a second price in the plurality of prices;
associating a first reward with the first price;
associating a second reward with the second price;
determining to provide a refund to a first acquirer of at least one of the plurality of items at the first price when a threshold is reached; and
selling one of the plurality of items for the first price by offering the first reward and the refund.

2. The method of claim 1, wherein determining to provide the refund further comprises determining to provide the refund to the first acquirer when a threshold number of items is acquired.

3. The method of claim 1, wherein determining to provide the refund further comprises determining to provide a refund to the first acquirer when a second acquirer acquires at least one of the plurality of items at the second price.

4. The method of claim 1, wherein determining to provide the refund further comprises determining to provide a refund to the first acquirer when a period of time elapses.

5. The method of claim 1, wherein determining to provide the refund further comprises determining to provide a refund to the first acquirer when the first acquirer requests the refund.

6. The method of claim 1 further comprising identifying a value of the first reward, based on the first price.

7. The method of claim 1 further comprising identifying, when a second acquirer acquires at least one of the plurality of items at the second price, the value of the refund to provide to the first acquirer.

8. The method of claim 1 further comprising identifying, when a threshold number of items is acquired, the value of the refund to provide to the first acquirer.

9. The method of claim 1 further comprising identifying, when a period of time elapses, the value of the refund to provide to the first acquirer.

10. The method of claim 1, wherein associating a second reward with the second price further comprises associating a second reward with the second price, the second reward having a lower value than a value of the first reward.

11. The method of claim 1, wherein associating a second reward with the second price further comprises associating a second reward with the second price, the second reward having a higher value than a value of the first reward.

12. The method of claim 1, wherein associating a second reward with the second price further comprises associating a second reward with the second price, the second reward having a substantially similar value as the first reward.

13. A computer readable medium having instructions thereon that when executed provide a method, the computer readable medium comprising:
instructions to identify a plurality of prices for a plurality of items, the plurality of prices including a first price that is higher than a second price in the plurality of prices;
instructions to associate a first reward with the first price;
instructions to associate a second reward with the second price;
instructions to determine to provide a refund to a first acquirer of at least one of the plurality of items at the first price when a threshold is reached; and
instructions to sell one of the plurality of items for the first price by offering the first reward and the refund.

14. A method for incentivizing an acquisition of a good or service, the method comprising:
identifying a plurality of prices for a plurality of items;
associating a first reward with a first price in the plurality of prices;
associating a second reward with a second price in the plurality of prices;
determining to provide the first reward to a first acquirer of at least one of the plurality of items at the first price when a threshold is reached; and
selling one of the plurality of items for the first price by offering the first reward.

15. The method of claim 14 further comprising identifying a value of the first reward, based on the first price.

16. The method of claim 14, wherein determining to provide the first reward further comprises determining to provide the first reward to the first acquirer when a period of time elapses.

17. The method of claim 14, wherein determining to provide the first reward further comprises determining to provide the first reward to the first acquirer when a quantity threshold is reached.

18. The method of claim 14, wherein determining to provide the first reward further comprises determining to provide the first reward to the first acquirer when a second acquirer acquires at least one of the plurality of items at the second price.

19. The method of claim 14 further comprising selling a second of the plurality of items for the second price by offering the second reward.

20. A method for identifying a price differential between two acquisitions of goods or services and incentivizing one of a plurality of acquirers, the method comprising:
providing, by an acquisition incentive system, to a first acquirer using a first client device, an identification of an acquisition opportunity;
receiving, by the acquisition incentive system, from the first client device, a request to acquire the item described by the identification of the acquisition opportunity at a first price described by the identification of the acquisition opportunity;
providing, by the acquisition incentive system, to the first acquirer, a first reward associated with the first price and described by the identification of the acquisition opportunity;
providing, by the acquisition incentive system, to a second acquirer using a second client device, the identification of an acquisition opportunity;
receiving, by the acquisition incentive system, from the second client device, a request to acquire a second item described by the identification of the acquisition opportunity at a second price described by the identification of the acquisition opportunity, the second price lower than the first price;
providing, by the acquisition incentive system, to the second acquirer, a second reward having a value lower than the first reward;
identifying, by the acquisition incentive system, a difference between the first price and the second price; and
refunding, by the acquisition incentive system, to the first acquirer, the identified difference between the first price and the second price.

21. The method of claim 20, wherein refunding the identified difference further comprises refunding the identified difference when a threshold number of items is sold.

22. The method of claim 20, wherein refunding the identified difference further comprises refunding the identified difference when the second acquirer acquires the second item at the second price.

23. The method of claim 20, wherein refunding the identified difference further comprises refunding the identified difference when a period of time elapses.

24. The method of claim 20, wherein refunding the identified difference further comprises refunding the identified difference when the first acquirer requests the refund.
